(19) United States
(12) Patent Application Publication
(10) Pub. No.: US 2025/0086225 A1
(43) Pub. Date: Mar. 13, 2025

(54) POINT CLOUD SEARCH USING MULTI-MODAL EMBEDDINGS

(71) Applicant: GM Cruise Holdings LLC, San Francisco, CA (US)

(72) Inventor: Carden Bagwell, San Francisco, CA (US)

(21) Appl. No.: 18/466,773

(22) Filed: Sep. 13, 2023

(51) Int. Cl. G06F 16/583; G06T 7/50; G06V 20/56; G06V 20/70

(52) U.S. Cl. CPC G06F 16/583; G06T 7/50; G06V 20/588; G06V 20/70; G06T 2207/10028

(57) ABSTRACT

Aspects of the disclosed technology provide solutions for searching point cloud data, such as Light Detection and Ranging (LiDAR) data and in particular, for using multi-modal embeddings for searching objects within a LiDAR data set. A process of the disclosed technology can include steps for receiving road data, wherein the road data represents a real-world environment encountered by an autonomous vehicle (AV) and wherein the road data comprises point cloud data representing a plurality of objects and generating, for each of the plurality of objects, a corresponding set of first embeddings. The process can further include steps for receiving a text string corresponding to a searched object, generating a second embedding corresponding to the searched object and identifying a matching object among the plurality of objects based on a comparison of the set of first embeddings and the second embedding. System and machine-readable media are also provided.

### BACKGROUND

### 1. Technical Field

The present disclosure generally relates to solutions for searching point cloud data, such as Light Detection and Ranging (LiDAR) data and in particular, for using multi-modal embeddings for searching objects within a LiDAR data set.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning, and obstacle avoidance.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example environment containing objects for which point cloud searching may be performed, according to some aspects of the disclosed technology.

FIG. 2A illustrates an example system of a machine learning (ML) model that receives image or text inputs, according to some aspects of the disclosed technology.

FIG. 2B illustrates an example system for training a ML model, according to some aspects of the disclosed technology.

FIG. 2C illustrates an example system for generating embeddings from a trained ML model, according to some aspects of the disclosed technology.

FIG. 2D illustrates an example system for facilitating the search of point cloud data using multi-modal embeddings, according to some aspects of the disclosed technology.

FIG. 3 illustrates an example of a process for using a machine-learning model to facilitate point cloud search using multimodal embeddings, according to some aspects of the disclosed technology.

FIG. 4 illustrates an example system that can be used to facilitate autonomous vehicle (AV) dispatch and operations, according to some aspects of the disclosed technology.

FIG. 5 illustrates an example of a deep learning neural network that can be used to label and search point cloud data, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

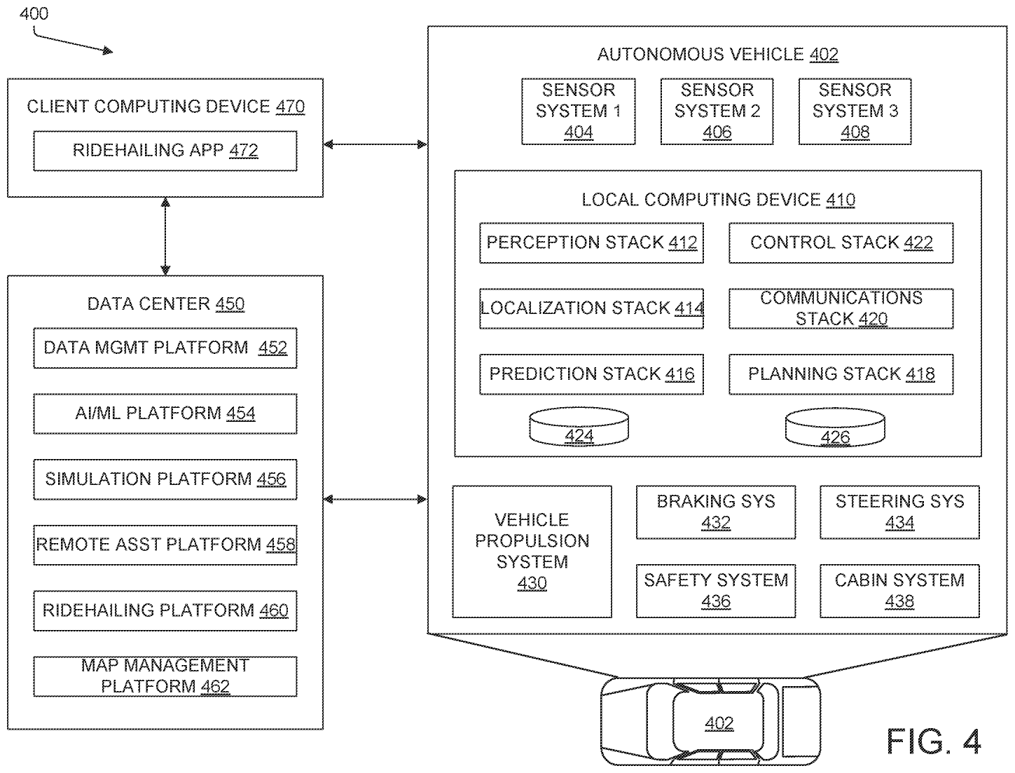

During operation, a perception layer of an autonomous vehicle can be used to help interpret and understand the surrounding environment by processing data collected from various sensors AV sensors, e.g., one or more Light Detection and Ranging (LiDAR), Radio Detection and Ranging (RADAR), camera, ultrasonic, Inertial Measurement Unit (IMU), and/or Global Navigation Satellite System (GNSS) sensors, and the like. By way of example, a LiDAR sensor can use light pulses to map the surroundings, e.g., as a collection of depth measurements (collectively, point cloud data). The perception layer (or perception stack) can include one or more machine-learning (ML) models designed to detect, track, and/or identify objects in the AV's environment. In some instances, various ML models can be used to process data from different sensor modalities. For example, object detection, identification and/or tracking for camera image data may be performed using a set of ML models that are separate and distinct from those used to process LiDAR point cloud data. Further descriptions relating to AV perception and other subsystems are provided in relation to FIG. 4 below.

Sensor data and other metadata (e.g., road data) collected during AV operations can be stored for further analysis, testing and/or training. In some instances, road data is used to train specific modules of the AV software stack, such as by exposing specific ML models to scenarios or instances for which performance should be improved. For example, AV perception may be improved through continued or additional testing of one or more ML detectors on a particularly difficult or problematic object class(es). By way of example, if an ML based LiDAR detector of the perception layer has difficulty distinguishing between cacti and humans (e.g., because a point cloud for a cactus may be similar to a point cloud of a person with arms extended), it would be beneficial to perform additional training using road data that includes those examples (e.g., cacti and humans). One difficulty in augmenting training on point cloud point objects in particular, is that they are not easily searchable, and therefore relevant or otherwise desirable training examples cannot be easily extracted from stored road data. For example, instances of “humans and cacti” cannot be easily searched in stored point cloud data using text string inputs, image inputs, and/or other point cloud inputs, making it difficult to find and extract relevant examples that may be used to perform further training, and to thereby improve AV performance on specific objects or scenarios.

Aspects of the disclosed technology provide solutions for searching point cloud data (e.g., LiDAR point cloud data) using a variety of input/query modalities, including but not limited to text input strings, images, and/or point cloud inputs. In some approaches, point cloud objects can be labeled/tagged with multimodal feature embeddings (also feature embeddings or embeddings) that represent latent characteristics of the corresponding object, such as a point cloud object. The multimodal feature embeddings can be used to characterize object characteristics for multiple sensor modalities and/or data types. For example, multimodal embeddings can embed object descriptors/characteristics for text labels, image data (e.g., RGB image space), and/or point cloud data. As used herein, feature embedding (also: embedding or embedding vector) can refer to a vector description of latent object characteristics. By training an ML model to generate embeddings of similar dimensionality using text, image, and/or point cloud inputs, point cloud objects can be searched by identifying those objects that are closest in Euclidean space to an embedding generated from the search query.

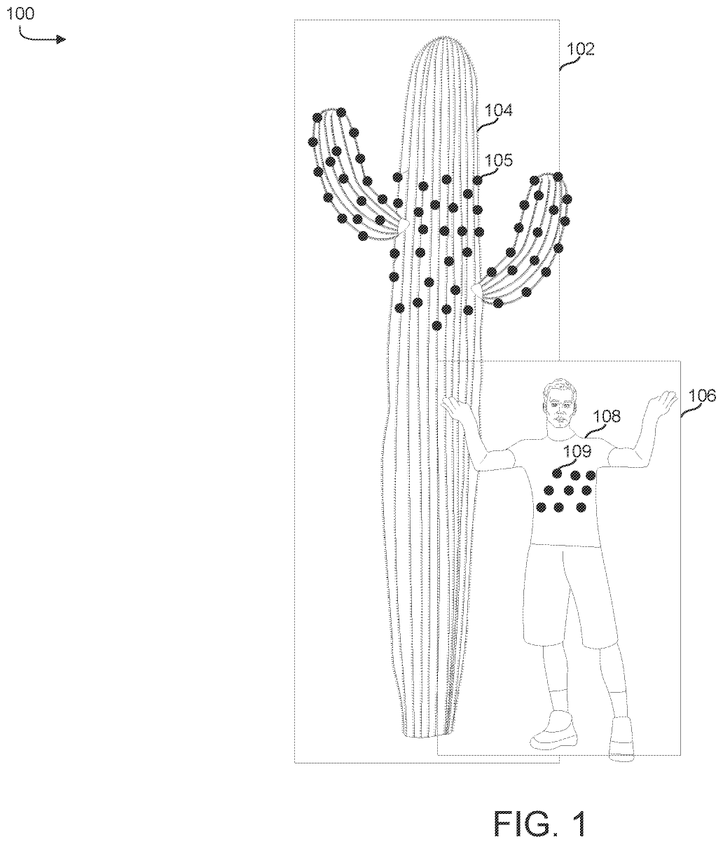

FIG. 1 illustrates an example environment 100 containing objects for which point cloud searching may be performed. In example environment 100, a first object 104 (e.g., a cactus) and a second object 108 (e.g., person) can be captured by using multiple AV sensor modalities, such as by using one or more camera sensors (resulting in image data representations of the objects) and LiDAR and/or RADAR sensors (resulting in point cloud representations of the objects). For example, first object 104 and second object 108 may be captured while the AV is autonomously navigating an environment or it may be derived from stored road data, possibly from a previous navigation instance. In the example environment 100, a camera sensor may capture image data for first object 104, which is identified by first bounding box 102 and for second object 106, which is identified by second bounding box 106. The LiDAR sensor may capture point cloud data for each object (104, 108) in environment 100, e.g., resulting in first point cloud 105 representative of first object 104 and second point cloud 109 representative of second object 108.

In instances where image-based ML detectors are used, first object 104 and second object 108 may be accurately distinguished, for example, due to the ability of image-based ML detectors to distinguish between objects using red, green, blue (RGB) color data. In other words, in the example environment 100, first object 104 (person) and second object 108 (cactus) may be distinguishable based on different distributions of RGB color data that is ingested by an image-based ML detector, enabling it to distinguish between the two objects.

For point cloud detectors (also: LiDAR detectors or LiDAR models), it can be difficult to achieve similar levels of detector accuracy, since point cloud data lacks the higher-dimensionality afforded by RGB image data. As such, LiDAR detectors can have difficulty distinguishing between objects with similar point clouds, for example, resulting from having similar shapes or structures. For example, LiDAR detectors can have difficulty distinguishing between objects of entirely different class types, but that share similar shape features, such as fire trucks and dumpsters, or cacti and people. As such, LiDAR based ML detectors may have difficulty distinguishing between first object 104 and second object 108 due to the similarities in the shapes and structures of first point cloud data 105 and second point cloud data 109.

In some aspects, a LiDAR detector may be trained by using embeddings derived from a LIDAR ML model (e.g., with LiDAR depth data as an input) and comparing it to embeddings derived from an image/text-based ML model. After training, the LiDAR detector may be able to more accurately distinguish between objects with similar point clouds. The embeddings derived from the image or text-based ML model may represent learned features about the objects in the image/text input. For example, for an image input, example embeddings may include, but are not limited to, shape, color, texture and position of the objects in the image. The LiDAR ML model may generate embeddings representing the spatial features or characteristics of the objects corresponding to the input such as the distance of the objects, their size, and their shape. Those skilled in the art will appreciate additional examples of elements in embedding vectors for LiDAR ML models and image or text-based ML models.

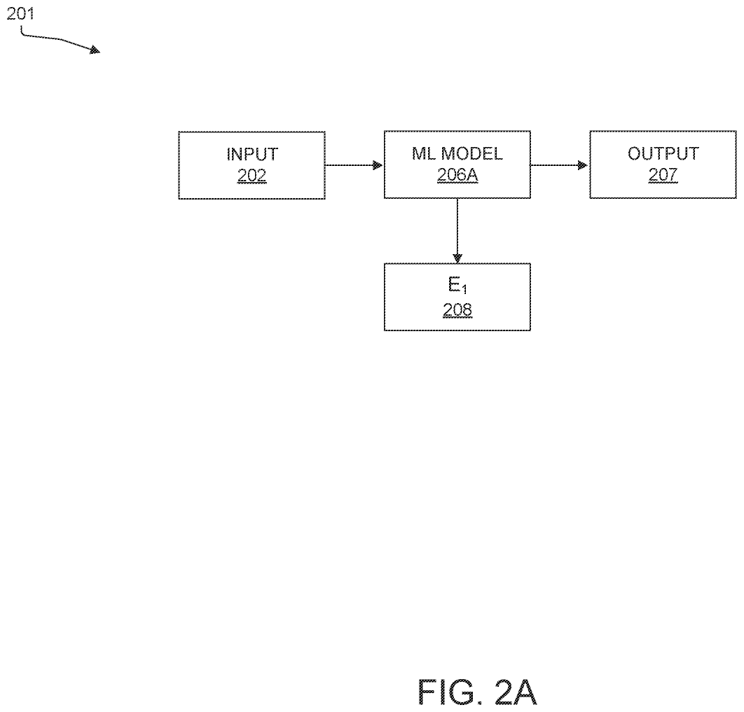

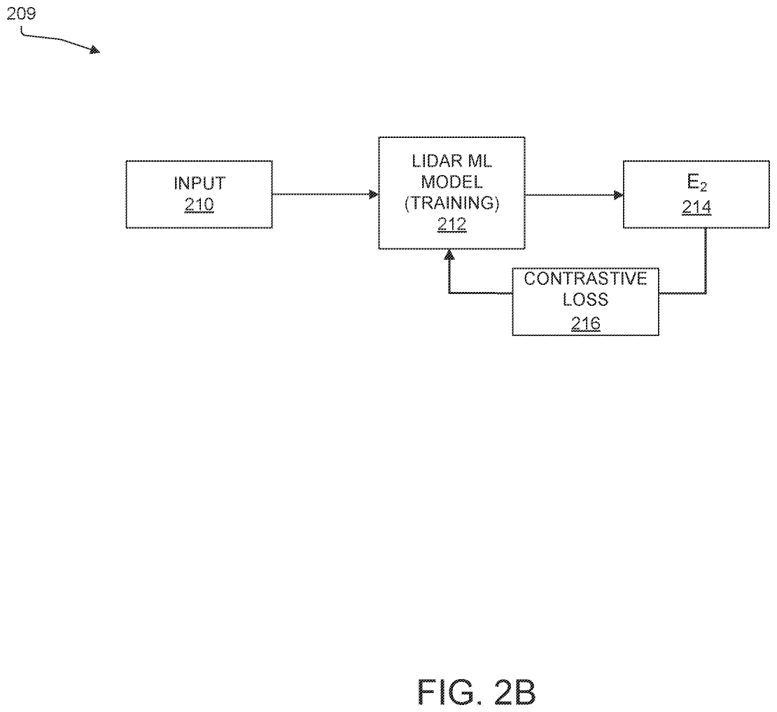

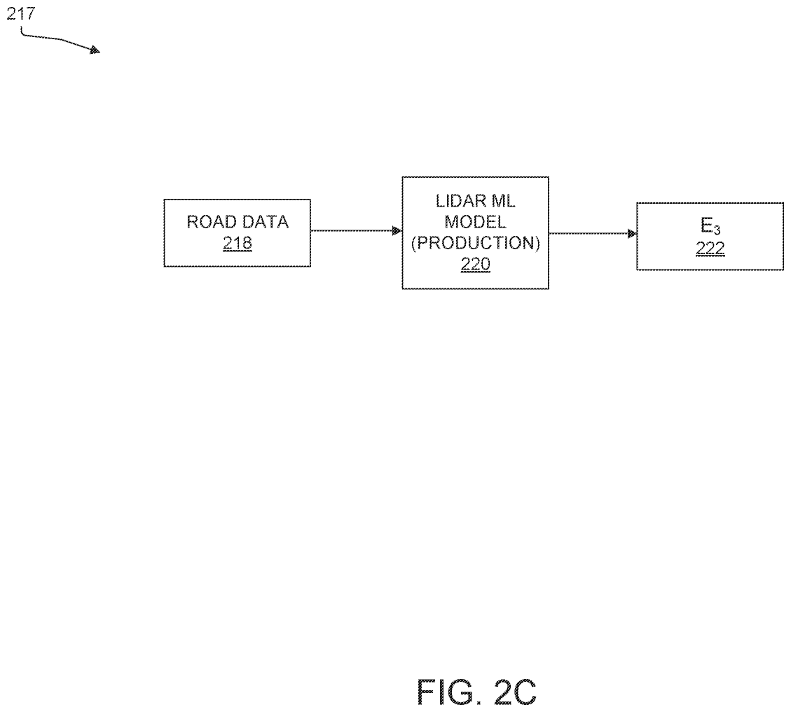

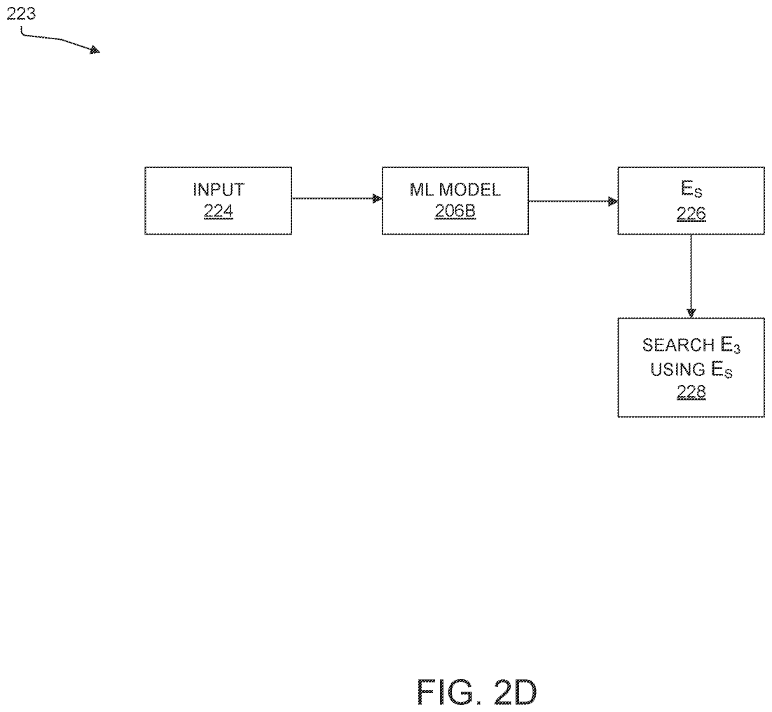

FIG. 2A illustrates an example system 201 of a machine learning (ML) model that receives image or text inputs. In some aspects, system 201 can be configured for training ML model 206A to generate an output 207 of text based on an input 202 of an image or corresponding images for corresponding text inputs 202. By way of example, ML model 206A may be trained using labeled image data such as by predicting text descriptions based on image inputs, and vice versa. With reference to FIG. 1, an input 202 of the image data corresponding to bounding box 102 along with a text description “cactus” may be used to train ML model 206A. In another example, image data corresponding to bounding box 106 along with a text description “person” may be used to train ML model 206A. After training, ML model 206A may generate an output 207 that correctly corresponds to input 202 (e.g., input 202 of bounding box 102 can correctly generate an output 207 of “cactus”).

Once trained, ML model 206A can also generate embeddings E1 208 corresponding to image or text data as input 202. The generated embeddings E1 208, can represent characteristic relationships between text descriptors and corresponding images, and may be used as ground truth data for training other ML models such as the LiDAR ML model 212 illustrated in FIG. 2B (e.g., the ML model 206A output 207 can be considered as true and accurate with respect to image or text as input 202). By way of example and with reference to FIG. 1, an input of bounding box 102 may generate embeddings E1 208 corresponding to the pixels inside bounding box 102 including first object 104 (e.g., a cactus). In some cases, an object such as cactus 104 may be segmented (e.g., the pixels corresponding to cactus 104 isolated from the rest of the pixels in bounding box 102) and ML model 206A can generate embeddings E1 208 based on pixels associated solely with the segmented object, such as cactus 104, and not based on any of the background pixels within bounding box 102. In some examples, ML model 206A may receive a text query (e.g., a text field designating an object such as “cactus”) and generate embeddings E1 208, accordingly.

FIG. 2B illustrates an example system 209 for training a ML model 212. LiDAR ML model 212 may receive LiDAR depth data pertaining to an object as an input 210. For example, a LiDAR point cloud of a scene or environment encountered by an AV and captured by a LiDAR sensor may include one or more objects. By way of example with reference to FIG. 1, LiDAR depth may be derived from first point cloud data 105 associated with cactus 104 or second point cloud data 109 associated with person 108. The LiDAR ML model 212 may generate embeddings, E2 214 based on the LiDAR depth of an object received as an input 210.

In some cases, a loss 216 may be calculated and used to train LiDAR ML model 212. For example, loss 216 may be calculated as the difference between E2 214 and E1 208, such as by computing the geometric or point-wise distance between E2 214 and E1 208 (e.g., a contrastive loss). Those skilled in the art will appreciate additional methods of calculating loss 216 can be used, without departing from the scope of the disclosed technology. By way of example, the training of LiDAR ML model 212 may be added to the LiDAR detector training, e.g., by including a contrastive loss function as part of an overall loss function that is used to train ML model 212. By training ML model 212 to reinforce similarities between E2 214 and E1 208, latent characteristics of point cloud data can be effectively mapped to latent characteristics of corresponding image/text pairs.

FIG. 2C illustrates an example system 217 for generating embeddings from a trained version of ML model 212, e.g., based on input point cloud data. The resulting trained LiDAR ML model 220 may generate embeddings (e.g., point-wise, voxel wise, and/or segment wise) E3 222 that resemble the embeddings E1 208 (e.g., illustrated in FIG. 2A) from the ground-truth data, or the output of ML model 206A. In some approaches, inputs to LiDAR ML model 220 can be provided from point cloud data, e.g., that has been extracted from road data 218 collected from previous navigation instances. In such instances, generated embeddings E3 222 can be associated with the corresponding point cloud data input. By way of example, each point in a point cloud may be associated with (or “tagged” with) a corresponding embedding E2 222, representing that point. In other aspects, point cloud groupings (e.g., volumetric representations of free or occupied space) or voxels can be associated with a given embedding E3 222. Similarly, segmented point cloud groupings, such as those belonging to a particular object, can be associated with the output embedding E3 222, as discussed in further detail below.

In some aspects, LiDAR ML model 220 generated embeddings, E3 222, should be geometrically close (e.g., Euclidean distance within a predetermined threshold of proximity) with embeddings E1 208. For example, geometrically close may refer to the geometric distance between embeddings E3 222 and embeddings E1 208 as being smaller than the geometric distance between embeddings E2 214 (e.g., generated from LiDAR ML model 212 illustrated in FIG. 2B) and embeddings E1 208.

By way of example, the geometric distance between embeddings E3 222 generated by LiDAR ML model 220 with first point cloud data 105 (e.g., as illustrated in FIG. 1) as an input and embeddings E1 208 generated by ML model 206A with bounding box 102 (e.g., image data associated with bounding box 102 including first object 104) as an input should be less than the geometric distance between embeddings E2 214 and E1 208 for the same set of inputs.

Embeddings E3 222 generated by LiDAR ML model 220 or embeddings E2 214 generated by LiDAR ML model 212 illustrated in FIG. 2B may be calculated for each point, or for a group of points representing a given volume of space (voxel). That is, embeddings may be calculated on a per-point, per-voxel and/or per-object basis. In instances where multiple points are labeled, such as for a voxel or segmented object, embeddings for multiple points corresponding with the object may be averaged, and the averaged embedding may be used to represent the corresponding object. For example, the points of the LiDAR point cloud may be grouped, and point-wise embeddings may be shared within all the points within that group. By way of example with reference to FIG. 1, first point cloud 105 or second point cloud 109 may be clustered and all the embeddings averaged, e.g., so that first point cloud 105 is represented by an averaged embedding that is calculated from some (or all) points contained within, and second point cloud 109 is represented by an averaged embedding based on some (or all) points contained within. Once embeddings have been associated with first point cloud 105 and/or second point cloud 109, the associated objects or voxel regions may be more easily searched using semantic queries, as discussed in further detail with respect to FIG. 2D.

FIG. 2D illustrates an example system 223 for facilitating point cloud data search using multi-modal embeddings, according to some aspects of the disclosed technology. The ML model 206B may represent ML model 206A as illustrated in FIG. 2A after training. The ML model 206B may receive a text string, image, or point cloud data as an input 224 and generate a corresponding embedding ES 226. By way of example, an input of text string “cactus” or an image of a cactus, e.g., image data associated with bounding box 102 as illustrated in FIG. 1, can generate corresponding embedding ES 226. The resulting embedding ES 226 can then be used to query a database of tagged point cloud objects, such as one or more objects that have been associated with a corresponding embedding, e.g., E3 222, as discussed above.

For example, with reference to FIG. 2C, LIDAR ML model 220 with road data 218 (e.g., a set of point cloud data for a set of objects) as an input can generate a set of embeddings E3 222 corresponding to each of one or more objects represented in road data 218. In other words, a database of embeddings E3 222 may be generated from road data 218 (e.g., LiDAR point cloud data) where each object in road data 218 is associated with a corresponding embedding E3 222. The database of embeddings E3 222 may be searched (e.g., as illustrated by module 228) based on (or using) ES 226. For example, consider an input 224 as text string “cactus” for which ML model 206B generates a corresponding embedding ES 226. In some aspects, the database or set of embeddings E3 222 may be searched by identifying the embedding E3 222 that is closest in distance (e.g., Euclidean distance) to embedding ES 226 (e.g., compared to all the other distances between ES 226 and E3 222).

As such, the road data 218, specifically the LiDAR point cloud data associated with a set of objects, may be searched by correlating the identified embedding E3 222 that is closest in distance to embedding ES 226 with the respective object in the LiDAR point cloud data set that generated the identified embedding E3 222. In some cases, the process as discussed above may be performed with input 224 as an image rather than a text string. In some aspects, comparisons between embeddings ES 226 (representing the search query) and E3 222 (representing point cloud to be searched), may be based on a threshold distance between the embedding vectors.

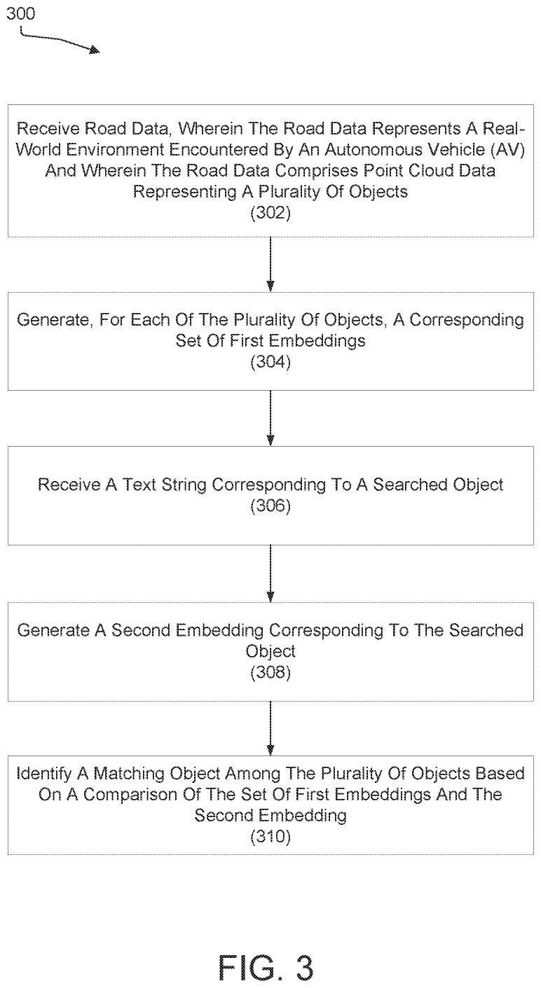

FIG. 3 illustrates an example of a process 300 for using a machine-learning model to facilitate point cloud search using multimodal embeddings, according to some aspects of the disclosed technology. At step 302, process 300 includes receiving road data, wherein the road data represents a real-world environment encountered by an autonomous vehicle (AV) and wherein the road data comprises point cloud data representing a plurality of objects. For example, an AV (e.g., AV 402) navigating a real-world environment may have sensors (e.g., sensor systems 404-408) that capture road data corresponding to the environment. The road data may include point cloud data generated by one or more LiDAR and/or RADAR sensors on the AV and image data generated by one or more AV camera sensors.

At block 304, process 300 includes generating, by a first ML model, for each of the plurality of objects, a corresponding set of first embeddings. For example, a set of embeddings may be generated by an ML model (e.g., LiDAR ML model 220 as illustrated in FIG. 2C) for corresponding objects in the road data (e.g., based on point cloud data including depth data associated with each object in the road data). As discussed above, the first ML model can be one that has been trained to generate embedding outputs using a loss function that is based on image/text embeddings. In some examples, an average of the point-wise embeddings corresponding to point cloud data for each object (e.g., segmented object) may be used to generate a set of embeddings per segmented object. The embeddings may be generated voxel-wise as a segmentation method can be used to cluster voxels (e.g., corresponding to an object) and the embeddings may be averaged over the segmented voxels.

At block 306, process 300 includes receiving, at a second ML model, a text string corresponding to a searched object. For example, an ML model (e.g., ML model 206B as illustrated in FIG. 2D) may receive a text string for a searched object. The text string may indicate an object to query within the plurality of objects (e.g., the LiDAR point cloud data). In some aspects, other input query types may be received, such as images and/or point cloud based descriptors. In such instances,

At block 308, process 300 includes generating, by the second ML model, a second embedding corresponding to the searched object. For example, an ML model (e.g., ML model 206B as illustrated in FIG. 2D) may generate an embedding based on the searched object. In some cases, the embedding is based on the text string associated with the searched object.

At block 310, process 300 includes identifying a matching object among the plurality of objects based on a comparison of the set of first embeddings and the second embedding. For example, the plurality of objects (e.g., LiDAR point cloud data for each object in the road data) may be searched based on comparing the second embedding (e.g., generated based on a text string describing the object search) with each embedding in the first set of embeddings, where each embedding in the first set of embeddings is generated by a point cloud for an object in the road data. In some aspects, an object in the LiDAR point cloud dataset may be identified as matching the searched object based on comparing the distance (e.g., Euclidean distance) of the embedding generated by the searched object (e.g., text string) and the embedding generated by each object in the LiDAR point cloud data. By way of example, if the distance between the second embedding and an embedding associated with an object in the LiDAR point cloud data is below a predetermined threshold, then the object may be identified as matching the searched object.

In some examples, the matching object is the lowest Euclidean distance in a set of distances. For example, a set of distances may be determined between each embedding corresponding to the LiDAR point cloud data and the second embedding. The lowest Euclidean distance in the set may be determined as matching the searched object. In some examples, process 300 includes receiving an image corresponding to the searched object, wherein the second embedding is based on the image. For example, an ML model (e.g., ML Model 206B as illustrated in FIG. 2D) may receive image data corresponding to the searched object. In some cases, the second embedding may be based on image data that may include the searched object located within a bounding box (e.g., the second embedding can be based on all the pixels in the bounding box including the searched object) or the searched object may be segmented (e.g., the second embedding is generated based on only the pixels associated with the searched object).

FIG. 4 is a diagram illustrating an example autonomous vehicle (AV) environment 400, according to some examples of the present disclosure. One of ordinary skill in the art will understand that, for AV environment 400 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include one or more types of sensors and can be arranged about the AV 402. For instance, the sensor systems 404-408 can include Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LiDAR system, and the sensor system 408 can be a RADAR system. Other examples may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some examples, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a localization stack 414, a prediction stack 416, a planning stack 418, a communications stack 420, a control stack 422, an AV operational database 424, and an HD geospatial database 426, among other stacks and systems.

Perception stack 412 can enable the AV 402 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can identify environmental uncertainties, such as where to look for moving objects, flag areas that may be obscured or blocked from view, and so forth. In some examples, an output of the perception stack 412 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 414 can determine the AV's position and orientation (pose) using different methods from multiple systems (e.g., GPS, IMUs, cameras, LiDAR, RADAR, ultrasonic sensors, the HD geospatial database 426, etc.). For example, in some cases, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LiDAR). If the mapping and localization information from one system is unavailable, the AV 402 can use mapping and localization information from a redundant system and/or from remote data sources.

Prediction stack 416 can receive information from the localization stack 414 and objects identified by the perception stack 412 and predict a future path for the objects. In some examples, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

Planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

Control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

Communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 426 can store HD maps and related data of the streets upon which the AV 402 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 424 can store raw AV data generated by the sensor systems 404-408, stacks 412-422, and other components of the AV 402 and/or data received by the AV 402 from remote systems (e.g., the data center 450, the client computing device 470, etc.). In some examples, the raw AV data can include HD LiDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

Data center 450 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 450 can include one or more computing devices remote to the local computing device 410 for managing a fleet of AVs and AV-related services. For example, in addition to managing the AV 402, the data center 450 may also support a ride-hailing service (e.g., a ridesharing service), a delivery service, a remote/roadside assistance service, street services (e.g., street mapping, street patrol, street cleaning, street metering, parking reservation, etc.), and the like.

Data center 450 can send and receive various signals to and from the AV 402 and the client computing device 470. These signals can include sensor data captured by the sensor systems 404-408, roadside assistance requests, software updates, ride-hailing/ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ride-hailing platform 460, and a map management platform 462, among other systems.

Data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ride-hailing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

Simulation platform 456 can enable testing and validation of the algorithms, machine learning models, neural networks, and other development efforts for the AV 402, the remote assistance platform 458, the ride-hailing platform 460, the map management platform 462, and other platforms and systems. Simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

Remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

Ride-hailing platform 460 can interact with a customer of a ride-hailing service via a ride-hailing application 472 executing on the client computing device 470. The client computing device 470 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 472. The client computing device 470 can be a customer's mobile computing device or a computing device integrated with the AV 402 (e.g., the local computing device 410). The ride-hailing platform 460 can receive requests to pick up or drop off from the ride-hailing application 472 and dispatch the AV 402 for the trip.

Map management platform 462 can provide a set of tools for the manipulation and management of geographic and spatial (geospatial) and related attribute data. The data management platform 452 can receive LiDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ride-hailing platform 460 may incorporate the map viewing services into the client application 472 to enable passengers to view the AV 402 in transit en route to a pick-up or drop-off location, and so on.

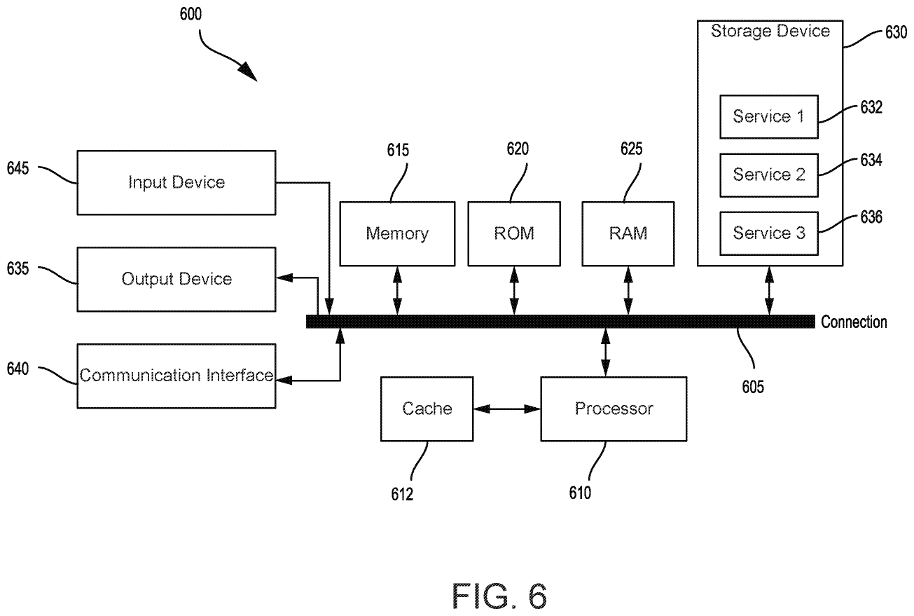

While the autonomous vehicle 402, the local computing device 410, and the autonomous vehicle environment 400 are shown to include certain systems and components, one of ordinary skill will appreciate that the autonomous vehicle 402, the local computing device 410, and/or the autonomous vehicle environment 400 can include more or fewer systems and/or components than those shown in FIG. 4. For example, the autonomous vehicle 402 can include other services than those shown in FIG. 4 and the local computing device 410 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 4. An illustrative example of a computing device and hardware components that can be implemented with the local computing device 410 is described below with respect to FIG. 6.

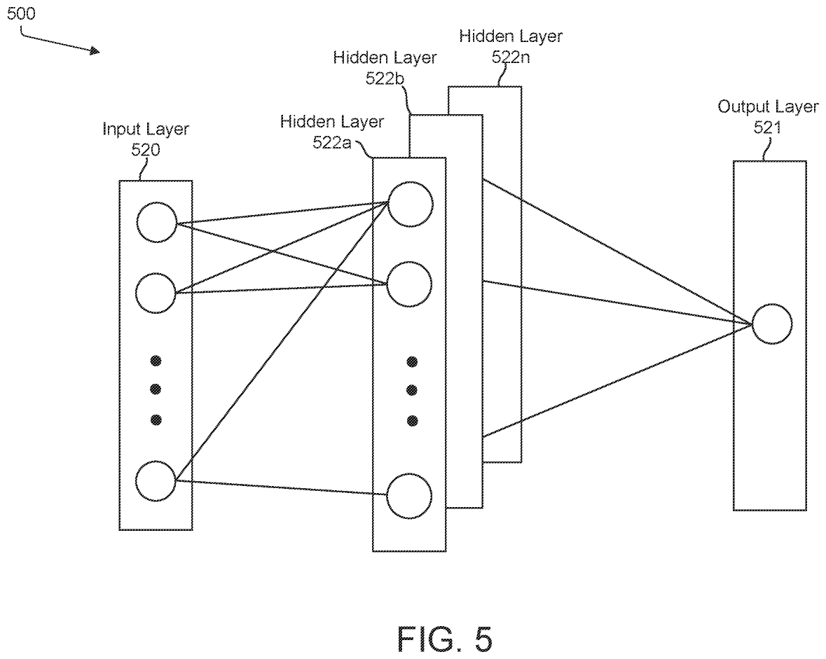

In FIG. 5, the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to implement ML model 206A or 206B, LiDAR ML model 212 and 220 as illustrated in FIG. 2, or any other ML model as described herein that can generate embeddings from an image, text, or LiDAR input). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. An apparatus comprising: at least one memory; and at least one processor coupled to the at least one memory, the at least one processor configured to: receive road data, wherein the road data represents a real-world environment encountered by an autonomous vehicle (AV) and wherein the road data comprises point cloud data representing a plurality of objects; generate, for each of the plurality of objects, a corresponding set of first embeddings; receive a text string corresponding to a searched object; generate a second embedding corresponding to the searched object; and identify a matching object among the plurality of objects based on a comparison of the set of first embeddings and the second embedding.

Aspect 2. The apparatus of Aspect 1, wherein the comparison is based on a set of distances between the second embedding and the set of first embeddings.

Aspect 3. The apparatus of Aspect 2, wherein the matching object is the lowest Euclidean distance in the set of distances.

Aspect 4. The apparatus of any of Aspects 1-3, wherein the second embedding is based on the text string.

Aspect 5. The apparatus of any of Aspects 1-4, wherein the at least one processor is further configured to: receive an image corresponding to the searched object.

Aspect 6. The apparatus of any of Aspects 1-5, wherein the second embedding is based on the image.

Aspect 7. The apparatus of any of Aspects 1-6, wherein each embedding in the set of first embeddings comprises a vector representing characteristics of the corresponding object.

Aspect 8. A computer-implemented method comprising: receiving road data, wherein the road data represents a real-world environment encountered by an autonomous vehicle (AV) and wherein the road data comprises point cloud data representing a plurality of objects; generating, for each of the plurality of objects, a corresponding set of first embeddings; receiving a text string corresponding to a searched object; generating a second embedding corresponding to the searched object; and identifying a matching object among the plurality of objects based on a comparison of the set of first embeddings and the second embedding.

Aspect 9. The computer-implemented method of Aspect 8, wherein the comparison is based on a set of distances between the second embedding and the set of first embeddings.

Aspect 10. The computer-implemented method of any of Aspects 8-9, wherein the matching object is the lowest Euclidean distance in the set of distances.

Aspect 11. The computer-implemented method of any of Aspects 8-10, wherein the second embedding is based on the text string.

Aspect 12. The computer-implemented method of any of Aspects 8-11, further comprising: receiving an image corresponding to the searched object.

Aspect 13. The computer-implemented method of any of Aspects 8-12, wherein the second embedding is based on the image.

Aspect 14. The computer-implemented method of any of Aspects 8-13, wherein each embedding in the set of first embeddings comprises a vector representing characteristics of the corresponding object.

Aspect 15. A non-transitory computer-readable storage medium comprising at least one instruction for causing a computer or processor to: receive road data, wherein the road data represents a real-world environment encountered by an autonomous vehicle (AV) and wherein the road data comprises point cloud data representing a plurality of objects; generate, for each of the plurality of objects, a corresponding set of first embeddings; receive a text string corresponding to a searched object; generate a second embedding corresponding to the searched object; and identify a matching object among the plurality of objects based on a comparison of the set of first embeddings and the second embedding.

Aspect 16. The non-transitory computer-readable storage medium of Aspect 15, wherein the comparison is based on a set of distances between the second embedding and the set of first embeddings.

Aspect 17. The non-transitory computer-readable storage medium of any of Aspects 15-16, wherein the matching object is the lowest Euclidean distance in the set of distances.

Aspect 18. The non-transitory computer-readable storage medium of any of Aspects 15-17, wherein the second embedding is based on the text string.

Aspect 19. The non-transitory computer-readable storage medium of any of Aspects 15-18, wherein the at least one instruction is further configured to: receive an image corresponding to the searched object.

Aspect 20. The non-transitory computer-readable storage medium of any of Aspects 15-19, wherein the second embedding is based on the image.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
receive road data, wherein the road data represents a real-world environment encountered by an autonomous vehicle (AV) and wherein the road data comprises point cloud data representing a plurality of objects;
generate, for each of the plurality of objects, a corresponding set of first embeddings;
receive a text string corresponding to a searched object;
generate a second embedding corresponding to the searched object; and
identify a matching object among the plurality of objects based on a comparison of the set of first embeddings and the second embedding.

2. The apparatus of claim 1, wherein the comparison is based on a set of distances between the second embedding and the set of first embeddings.

3. The apparatus of claim 2, wherein the matching object is the lowest Euclidean distance in the set of distances.

4. The apparatus of claim 1, wherein the second embedding is based on the text string.

5. The apparatus of claim 1, wherein the at least one processor is further configured to:
receive an image corresponding to the searched object.

6. The apparatus of claim 5, wherein the second embedding is based on the image.

7. The apparatus of claim 1, wherein each embedding in the set of first embeddings comprises a vector representing characteristics of the corresponding object.

8. A computer-implemented method comprising:
receiving road data, wherein the road data represents a real-world environment encountered by an autonomous vehicle (AV) and wherein the road data comprises point cloud data representing a plurality of objects;
generating, for each of the plurality of objects, a corresponding set of first embeddings;
receiving a text string corresponding to a searched object;
generating a second embedding corresponding to the searched object; and
identifying a matching object among the plurality of objects based on a comparison of the set of first embeddings and the second embedding.

9. The computer-implemented method of claim 8, wherein the comparison is based on a set of distances between the second embedding and the set of first embeddings.

10. The computer-implemented method of claim 9, wherein the matching object is the lowest Euclidean distance in the set of distances.

11. The computer-implemented method of claim 8, wherein the second embedding is based on the text string.

12. The computer-implemented method of claim 8, further comprising:
receiving an image corresponding to the searched object.

13. The computer-implemented method of claim 12, wherein the second embedding is based on the image.

14. The computer-implemented method of claim 8, wherein each embedding in the set of first embeddings comprises a vector representing characteristics of the corresponding object.

15. A non-transitory computer-readable storage medium comprising at least one instruction for causing a computer or processor to:
receive road data, wherein the road data represents a real-world environment encountered by an autonomous vehicle (AV) and wherein the road data comprises point cloud data representing a plurality of objects;
generate, for each of the plurality of objects, a corresponding set of first embeddings;
receive a text string corresponding to a searched object;
generate a second embedding corresponding to the searched object; and
identify a matching object among the plurality of objects based on a comparison of the set of first embeddings and the second embedding.

16. The non-transitory computer-readable storage medium of claim 15, wherein the comparison is based on a set of distances between the second embedding and the set of first embeddings.

17. The non-transitory computer-readable storage medium of claim 16, wherein the matching object is the lowest Euclidean distance in the set of distances.

18. The non-transitory computer-readable storage medium of claim 15, wherein the second embedding is based on the text string.

19. The non-transitory computer-readable storage medium of claim 15, wherein the at least one instruction is further configured to:
receive an image corresponding to the searched object.

20. The non-transitory computer-readable storage medium of claim 19, wherein the second embedding is based on the image.
